(19) United States
(12) Patent Application Publication
(10) Pub. No.: US 2025/0377205 A1
(43) Pub. Date: Dec. 11, 2025

(54) ROUTE NAVIGATION

(71) Applicant: Ford Global Technologies, LLC, Dearborn, MI (US)

(72) Inventors: Md Nahid Pervez, San Jose, CA (US); Martin Hudson Miller, Sunnyside, NY (US); Aakar Mehra, Seattle, WA (US); Ganesh Kumar, Santa Clara, CA (US); Zhilai Shen, San Jose, CA (US); Priyanka Kulkarni, New Hudson, MI (US)

(73) Assignee: Ford Global Technologies, LLC, Dearborn, MI (US)

(21) Appl. No.: 18/739,819

(22) Filed: Jun. 11, 2024

(51) Int. Cl. G01C 21/28

(52) U.S. Cl. CPC G01C 21/28

(57) ABSTRACT

A computer includes a processor and a memory, and the memory stores instructions executable by the processor to generate a corridor defining a geometric area surrounding a road-level navigation route for a vehicle; apply the corridor to a lane-level map, the lane-level map including a plurality of lane segments, each lane segment defining a lane of a road from one endpoint to another endpoint; populate a lane-segment set with a subset of the lane segments from the lane-level map based on the application of the corridor to the lane-level map; and determine a lane-level navigation route based on the lane-segment set, the lane-level navigation route following the road-level navigation route.

### BACKGROUND

Vehicles can travel along routes from a first destination to a second destination. A road included in a route can include more than one of lane of travel in a given travel direction such that a vehicle on a route may select a lane of travel.

### BRIEF DESCRIPTION OF THE DRAWINGS

FIG. 1 is a block diagram of an example vehicle.

FIG. 2 is a diagram of a road-level map with a road-level navigation route and associated corridor.

FIG. 3 is a diagram of a lane-level map with the road-level navigation route and associated corridor applied.

FIG. 4 is a flowchart of an example process for determining a lane-level navigation route and operating the vehicle along the lane-level navigation route.

### DETAILED DESCRIPTION

The disclosure describes determining a lane-level navigation route for a vehicle to follow. The determination can convert a road-level navigation route into a lane-level navigation route, allowing for more finely tuned control of the vehicle. A road-level navigation route includes instructions for the vehicle to follow to move from road segment to road segment, e.g., when to exit an expressway, which direction to turn at an intersection, etc. A lane-level navigation route further includes instructions for the vehicle to follow to change lanes within the same road segment. Such instructions are not included in the road-level navigation route.

To determine a lane-level navigation route that follows a road-level navigation route, a computer on board the vehicle is programmed to generate a corridor surrounding the road-level navigation route and apply the corridor to a lane-level map. The lane-level map includes map data for individual lanes within road segments, specifically, a plurality of lane segments. Each lane segment defines a lane of a road from one endpoint to another endpoint. Next, the computer is programmed to populate a lane-segment set with a subset of the lane segments from the lane-level map based on the application of the corridor to the lane-level map, and to determine the lane-level navigation route based on the lane-segment set. For example, the computer may perform a search algorithm for finding an optimal route traversing the lane segments in the lane-segment set, which can be represented as a network graph. Finally, the computer may be programmed to operate the vehicle to follow the lane-level navigation route, e.g., using an advanced driver assistance system (ADAS).

The computer can determine the road-level navigation route and the lane-level navigation route over different distance horizons. For example, the road-level navigation route may cover the entirety of the route to a final destination, and the lane-level navigation route may cover a preset distance forward along the road-level navigation route, e.g., 7 kilometers. Moreover, disparate sources can be used for determining the road-level navigation route and the lane-level navigation route. The road-level navigation route may be generated from a road-level map, whereas the lane-level navigation route is generated from the lane-segment set taken from the lane-level map.

A computer includes a processor and a memory, and the memory stores instructions executable by the processor to generate a corridor defining a geometric area surrounding a road-level navigation route for a vehicle; apply the corridor to a lane-level map, the lane-level map including a plurality of lane segments, each lane segment defining a lane of a road from one endpoint to another endpoint; populate a lane-segment set with a subset of the lane segments from the lane-level map based on the application of the corridor to the lane-level map; and determine a lane-level navigation route based on the lane-segment set, the lane-level navigation route following the road-level navigation route.

In an example, the instructions may further include instructions to operate the vehicle to follow the lane-level navigation route.

In an example, the instructions may further include instructions to operate a steering system of the vehicle to follow the lane-level navigation route. In a further example, the instructions to operate the steering system to follow the lane-level navigation route may include instructions to perform a lane change.

In an example, the corridor may extend laterally from the road-level navigation route for a preset width centered on the road-level navigation route. In a further example, the preset width may be greater than a width of one of the lane segments.

In an example, the corridor follows the road-level navigation route up to a preset travel horizon.

In an example, the instructions may further include instructions to include the lane segments that at least partially intersect the corridor as applied to the lane-level map in the lane-segment set. In a further example, the instructions may further include instructions to individually determine whether the lane segments in the lane-level map intersect the corridor as applied to the lane-level map in an order starting with a closest lane segment to the vehicle. In a still further example, the order may progress through the lane segments laterally touching the lane segments in the lane-segment set until one of the lane segments does not intersect the corridor.

In another still further example, the order may progress in a vehicle-forward direction through the lane segments longitudinally touching the lane segments in the lane-segment set until one of the lane segments does not intersect the corridor.

In an example, the road-level navigation route may be generated from a road-level map.

In an example, the instructions may further include instructions to determine a transformation between a road-level map and the lane-level map, and apply the corridor to the lane-level map based on the transformation.

In an example, the lane segments in the lane-segment set may define a network graph, and the instructions may further include instructions to determine the lane-level navigation route by searching for an optimal route traversing the network graph.

A method includes generating a corridor defining a geometric area surrounding a road-level navigation route for a vehicle; applying the corridor to a lane-level map, the lane-level map including a plurality of lane segments; populating a lane-segment set with a subset of the lane segments from the lane-level map based on the application of the corridor to the lane-level map, each lane segment defining a lane of a road from one endpoint to another endpoint; and determining a lane-level navigation route based on the lane-segment set, the lane-level navigation route following the road-level navigation route.

In an example, the method may further include operating the vehicle to follow the lane-level navigation route.

In an example, the corridor may extend laterally from the road-level navigation route for a preset width centered on the road-level navigation route.

In an example, the method may further include including the lane segments that at least partially intersect the corridor as applied to the lane-level map in the lane-segment set.

In an example, the road-level navigation route may be generated from a road-level map.

In an example, the method may further include determining a transformation between a road-level map and the lane-level map, and applying the corridor to the lane-level map based on the transformation.

With reference to the Figures, wherein like numerals indicate like parts throughout the several views, a computer 105 includes a processor and a memory, and the memory stores instructions executable by the processor to generate a corridor 205 defining a geometric area surrounding a road-level navigation route 210 for a vehicle 100; apply the corridor 205 to a lane-level map 300, the lane-level map 300 including a plurality of lane segments 305, each lane segment 305 defining a lane 310 of a road 215 from one endpoint 315 to another endpoint 315; populate a lane-segment set 325 with a subset of the lane segments 305 from the lane-level map 300 based on the application of the corridor 205 to the lane-level map 300; and determine a lane-level navigation route 320 based on the lane-segment set 325, the lane-level navigation route 320 following the road-level navigation route 210.

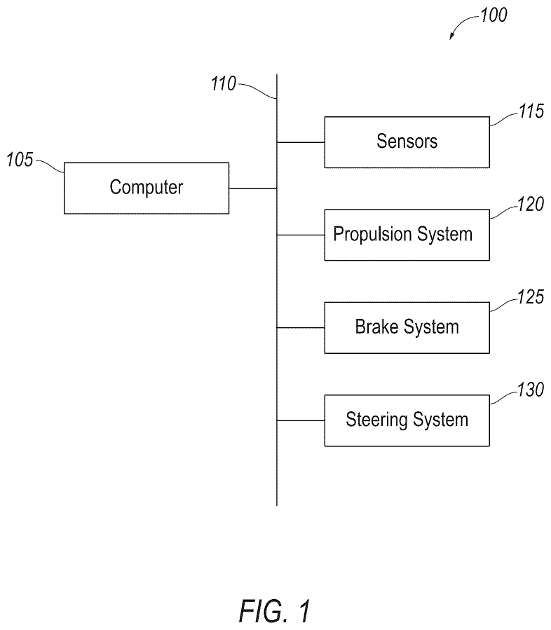

With reference to FIG. 1, the vehicle 100 may be any passenger or commercial automobile such as a car, a truck, a sport utility vehicle, a crossover, a van, a minivan, a taxi, a bus, etc. The vehicle 100 may include the computer 105, a communications network 110, sensors 115, a propulsion system 120, a brake system 125, and a steering system 130.

The computer 105 is a microprocessor-based computing device, e.g., a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. The computer 105 can thus include a processor, a memory, etc. The memory of the computer 105 can include media for storing instructions executable by the processor as well as for electronically storing data and/or databases, and/or the computer 105 can include structures such as the foregoing by which programming is provided. The computer 105 can be multiple computers coupled together.

The computer 105 may transmit and receive data through the communications network 110. The communications network 110 may be, e.g., a controller area network (CAN) bus, Ethernet, WiFi, Local Interconnect Network (LIN), onboard diagnostics connector (OBD-II), and/or any other wired or wireless communications network. The computer 105 may be communicatively coupled to the sensors 115, the propulsion system 120, the brake system 125, the steering system 130, and other components via the communications network 110.

The sensors 115 may provide data about operation of the vehicle 100, for example, wheel speed, wheel orientation, and engine and transmission data (e.g., temperature, fuel consumption, etc.). The sensors 115 may detect the location and/or orientation of the vehicle 100. For example, the sensors 115 may include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors 115 may detect the external world, e.g., objects and/or characteristics of surroundings of the vehicle 100, such as other vehicles, road lane markings, traffic lights and/or signs, road users, etc. For example, the sensors 115 may include radar sensors, ultrasonic sensors, scanning laser range finders, light detection and ranging (lidar) devices, and image processing sensors such as cameras.

The propulsion system 120 of the vehicle 100 generates energy and translates the energy into motion of the vehicle 100. The propulsion system 120 may be a conventional vehicle propulsion subsystem, for example, a conventional powertrain including an internal-combustion engine coupled to a transmission that transfers rotational motion to wheels; an electric powertrain including batteries, an electric motor, and a transmission that transfers rotational motion to the wheels; a hybrid powertrain including elements of the conventional powertrain and the electric powertrain; or any other type of propulsion. The propulsion system 120 can include an electronic control unit (ECU) or the like that is in communication with and receives input from the computer 105 and/or a human operator. The human operator may control the propulsion system 120 via, e.g., an accelerator pedal and/or a gear-shift lever.

The brake system 125 is typically a conventional vehicle braking subsystem and resists the motion of the vehicle 100 to thereby slow and/or stop the vehicle 100. The brake system 125 may include friction brakes such as disc brakes, drum brakes, band brakes, etc.; regenerative brakes; any other suitable type of brakes; or a combination. The brake system 125 can include an electronic control unit (ECU) or the like that is in communication with and receives input from the computer 105 and/or a human operator. The human operator may control the brake system 125 via, e.g., a brake pedal.

The steering system 130 is typically a conventional vehicle steering subsystem and controls the turning of the wheels. The steering system 130 may be a rack-and-pinion system with electric power-assisted steering, a steer-by-wire system, as both are known, or any other suitable system. The steering system 130 can include an electronic control unit (ECU) or the like that is in communication with and receives input from the computer 105 and/or a human operator. The human operator may control the steering system 130 via, e.g., a steering wheel.

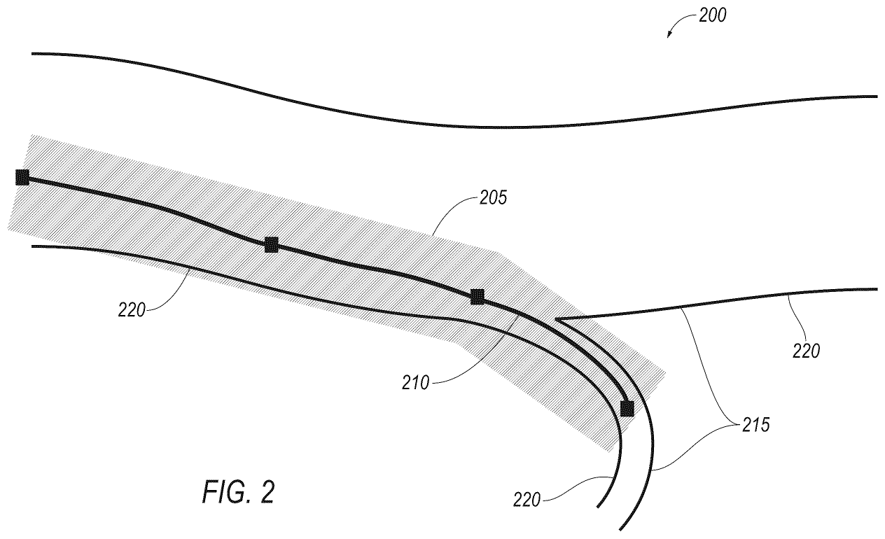

With reference to FIG. 2, the computer 105 may store a road-level map 200 in memory. The computer 105 may receive the road-level map 200 from a remote server or already have the road-level map 200 prestored in the memory. The road-level map 200 includes representations of roads 215 as well as possibly other traffic control data, e.g., posted speed limits, stoplights, and other posted traffic instructions. The roads 215 may be represented as collections of road segments 220, e.g., with a road segment 220 spanning from one road intersection to another road intersection. The road-level map 200 may define positions of the road segments 220 and other items in a coordinate system. The coordinate system may be a local system for the road-level map 200 or a global system, e.g., to match with the coordinate system of a global navigation satellite system (GNSS). The road-level map 200 lacks data describing individual lanes 310 within a road segment 220, e.g., data describing the positions of the lanes 310.

The road-level navigation route 210 includes instructions for the vehicle 100 to follow to move from road segment 220 to road segment 220, e.g., when to exit an expressway, which direction to turn at an intersection, etc. The road-level navigation route 210 may include instructions from a starting point or current location of the vehicle 100 to a final destination.

The road-level navigation route 210 is generated from the road-level map 200. For example, the computer 105 may determine the road-level navigation route 210 that optimally traverses the road segments 220 of the road-level map 200, e.g., according to a route-planning algorithm as is known, e.g., Dijkstra's algorithm, bidirectional search, geometric goal-directed search, reach-based routing, highway hierarchies, highway-node routing, SHARC, etc. For another example, a remote server distinct from the vehicle 100 may determine the road-level navigation route 210, and the computer 105 may receive the road-level navigation route 210 from the remote server. The remote server may be a cloud computing center, a mobile device of an operator of the vehicle 100, etc.

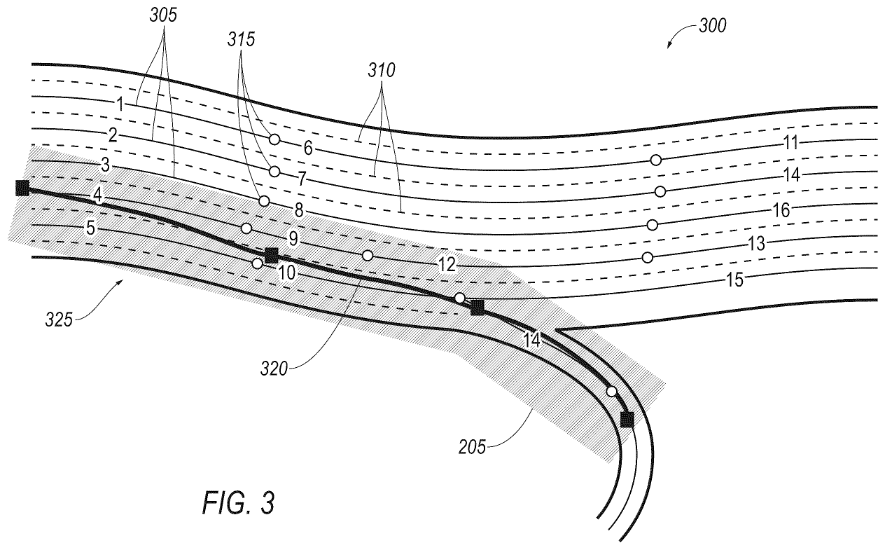

FIG. 2 shows the corridor 205. The corridor 205 defines a geometric area surrounding the road-level navigation route 210 for the vehicle 100. The corridor 205 may extend laterally outward from both sides of the road-level navigation route 210 as well as longitudinally along the road-level navigation route 210. For the purposes of this disclosure, “laterally” is defined as perpendicular to the direction of the navigation route or the direction of travel of the vehicle 100, and “longitudinally” is defined as parallel to the direction of the navigation route or the direction of travel of the vehicle 100. For example, the corridor 205 may extend laterally from the road-level navigation route 210 for a preset width centered on the road-level navigation route 210. The preset width may be chosen to encompass a sufficient number of lane segments 305 for determining the lane-level navigation route 320 (as described below with respect to FIG. 3). The preset width is greater than a width of one of the lane segments 305. The corridor 205 may follow the road-level navigation route 210 (i.e., extend longitudinally) up to a preset travel horizon. The preset travel horizon may be chosen to provide sufficient space for the vehicle 100 to follow the lane-level navigation route 320, e.g., to perform lane changes to exit an expressway as in the example of FIGS. 2 and 3, e.g., 7 kilometers.

The computer 105 is programmed to generate the corridor 205. For example, the computer 105 may generate a series of polygons, e.g., rectangles, having widths equal to twice the preset width and placing the polygons on the road-level navigation route 210. The lengths of the rectangles may be preset or may vary depending on the curvature of the road-level navigation route 210, with greater curvature corresponding to shorter length. The rectangles may be centered laterally on points on the road-level navigation route 210, the points spaced longitudinally from each other according to the lengths of the rectangles. The rectangles may be aligned with their lengths in the same direction as the longitudinal direction of the road-level navigation route 210. The corridor 205 is the area covered by the rectangles. For another example, the computer 105 may determine points on both sides of the road-level navigation route 210 that are spaced by the preset width from the road-level navigation route 210 in a lateral direction relative to the road-level navigation route 210. The computer 105 may connect the points on each side of the road-level navigation route 210 to define the corridor 205.

With reference to FIG. 3, the computer 105 may store a lane-level map 300 in memory. The computer 105 may receive the lane-level map 300 from a remote server or already have the lane-level map 300 prestored in the memory. The lane-level map 300 may include representations of the same traffic control and environmental features as the road-level map 200. The lane-level map 300 further includes data describing individual lanes 310 forming the roads 215. The lanes 310 are represented as lane segments 305, and the lane-level map 300 includes a plurality of the lane segments 305. The lane-level map 300 may define positions of the lane segments 305 and other items in a coordinate system. The coordinate system may be a local system for the lane-level map 300.

Each lane segment 305 defines a lane 310 of a road 215 from one endpoint 315 to another endpoint 315. (For clarity, only some of the lane segments 305, lanes 310, and endpoints 315 are labeled with reference numbers in FIG. 3.) The endpoints 315 may be spaced longitudinally from each other along the respective lane 310 evenly or unevenly, and one lane 310 may contain two or more than two endpoints 315. The endpoints 315 may be centered in the respective lane 310. The lane segment 305 may follow a centerline of the lane 310 between the endpoints 315. Two or more lane segments 305 may terminate at each endpoint 315. Generally two lane segments 305 terminate at an endpoint 315 and define a single ongoing lane 310 passing through the endpoint 315. At other locations, three or possibly more lane segments 305 terminate at an endpoint 315, e.g., where a lane 310 splits, an offramp begins, a lane 310 or onramp merges into another lane 310, etc.

The computer 105 may be programmed to determine a transformation between the road-level map 200 and the lane-level map 300. The transformation describes a conversion between positions of the same features in the road-level map 200 and the lane-level map 300, i.e., maps the positions in the road-level map 200 to the lane-level map 300 (or vice versa). The transformation may be a geometric transformation, e.g., may include a rotation and translation that, when applied to a position in the road-level map 200, makes the position coincide with the position of the same feature in the lane-level map 300 (or vice versa). The computer 105 may determine the transformation based on a prestored reference point in one of the road-level map 200 or the lane-level map 300, e.g., in the lane-level map 300. The reference point in the lane-level map 300 may have a known position in the road-level map 200, e.g., in the GNSS coordinate system. The transformation may convert a position in the lane-level map 300 represented relative to the reference point to a corresponding position in the road-level map 200.

The computer 105 is programmed to apply the corridor 205 to the lane-level map 300. The computer 105 may superimpose the corridor 205 onto the lane-level map 300 at a corresponding position and orientation in the lane-level map 300. For example, the computer 105 may apply the corridor 205 to the lane-level map 300 based on the transformation. The corridor 205 may be represented by the vertices of the polygons or by the points that are the preset distance from the road-level navigation route 210, as described above. The computer 105 may apply the corridor 205 to the lane-level map 300 by using the transformation to convert the positions of the vertices or points in the road-level map 200 to corresponding positions in the lane-level map 300.

As will be described below, the computer 105 determines the lane-level navigation route 320 based on a lane-segment set 325. The lane-segment set 325 may start as an empty set, and the computer 105 may reset the lane-segment set 325 to be empty whenever the process of determining the lane-level navigation route 320 restarts, e.g., periodically. Once populated as described below, the lane-segment set 325 includes a plurality of the lane segments 305 from the lane-level map 300. The lane-segment set 325 includes a subset of the lane segments 305 from the lane-level map 300, i.e., fewer than all the lane segments 305 in the lane-level map 300. The lane-segment set 325 may be represented as an unordered list or as tags for each lane segment 305 indicating whether the lane segment 305 is in or out of the lane-segment set 325.

The computer 105 is programmed to populate the lane-segment set 325 with a subset of the lane segments 305 from the lane-level map 300. The computer 105 may include the lane segments 305 that at least partially intersect the corridor 205 as applied to the lane-level map 300 in the lane-segment set 325. The lane segments 305 included in the lane-segment set 325 may intersect the corridor 205 by being contained within the corridor 205, i.e., overlapping the corridor 205, e.g., the lane segments 305 “5” or “10” in FIG. 3, or by being partially within the corridor 205, i.e., partially overlapping the corridor 205, e.g., the lane segments 305 “3” or “12” in FIG. 3. The computer 105 may include the lane segments 305 having at least a preset fraction of their length within the corridor 205 or the lane segments 305 having any portion within the corridor 205.

The computer 105 may individually determine whether the lane segments 305 in the lane-level map 300 intersect the corridor 205 in an order, i.e., determine whether one of the lane segments 305 intersects the corridor 205, then select a next lane segment 305 according to the order, then determine whether the selected lane segment 305 intersects the corridor 205, then select a next lane segment 305 according to the order, and so on. The order may follow predefined rules. Using the order may permit the computer 105 to test fewer than all the lane segments 305 for inclusion, making the processing faster. The predefined rules may specify a termination condition for ceasing testing of the lane segments 305, as will be described below. The order may start with a closest lane segment 305 to the vehicle 100, e.g., the lane segment 305 “4” in FIG. 3.

The order may progress through the lane segments 305 laterally touching the lane segments 305 in the lane-segment set 325 until one of the lane segments 305 does not intersect the corridor 205. Two lane segments 305 are “laterally touching” if one lane segment 305 is next to the other lane segment 305 such that the vehicle 100 could change lanes 310 from the one lane segment 305 to the other lane segment 305. The computer 105 may, in response to a lane segment 305 being added to the lane-segment set 325, determine whether any of the lane segments 305 laterally touching the added lane segment 305 intersect the corridor 205. In the example of FIG. 3, the first lane segment 305 added to the lane-segment set 325 is the lane segment 305 “4.” The lane segments 305 laterally touching the lane segment 305 “4” are the lane segments 305 “3” and “5,” so the computer 105 then determines that the lane segments 305 “3” and “5” intersect the corridor 205. In response to adding the lane segment 305 “3,” the computer 105 then determines whether the lane segment 305 “2,” which laterally touches the lane segment 305 “3,” intersects the corridor 205. Because the lane segment 305 “2” does not intersect the corridor 205, the computer 105 does not determine whether the lane segment 305 “1” intersects the corridor 205. Instead, the computer 105 leaves the lane segment 305 “1” out of the lane-segment set 325 without testing the lane segment 305 “1.” No untested lane segments 305 laterally touch the lane segment 305 “5,” so the addition of the lane segment 305 “5” does not prompt the computer 105 to test any other laterally touching lane segments 305. In response to adding a longitudinally touching lane segment 305 such as the lane segment 305 “9” (described immediately below), the computer 105 then tests the lane segments 305 laterally touching the added lane segment 305, e.g., the lane segments 305 “8” and “10.” The computer 105 includes the lane segment 305 “10” in the lane-segment set 325 and does not include the lane segment 305 “8” in the lane-segment set 325.

The order may progress in a vehicle-forward direction through the lane segments 305 longitudinally touching the lane segments 305 in the lane-segment set 325 until one of the lane segments 305 does not intersect the corridor 205. Two lanes 310 are “longitudinally touching” if one of the lane segments 305 follows the other lane segment 305 such that the vehicle 100 could travel forward from the one lane segment 305 to the other lane segment 305. The computer 105 may, in response to a lane segment 305 being added to the lane-segment set 325, determine whether any of the lane segments 305 longitudinally touching the added lane segment 305 in the vehicle-forward direction from the added lane segment 305 intersect the corridor 205. The lane-level map 300 may have data specifying the vehicle-forward direction, i.e., the direction of travel for the lane segments 305. In the example of FIG. 3, the first lane segment 305 added to the lane-segment set 325 is the lane segment 305 “4.” The lane segment 305 that is laterally touching the lane segment 305 “4” in the vehicle-forward direction is the lane segment 305 “9,” so the computer 105 then determines that the lane segment 305 “9” intersects the corridor 205. In response to adding the lane segment 305 “9,” the computer 105 determines that the lane segment 305 “12,” which longitudinally touches the lane segment 305 “9” in the vehicle-forward direction, intersects the corridor 205. In response to adding the lane segment 305 “12,” the computer 105 determines that the lane segment 305 “13,” which longitudinally touches the lane segment 305 “12” in the vehicle-forward direction, does not intersect the corridor 205. In response to adding the lane segment 305 “5” for laterally touching the lane segment 305 “4,” the computer 105 determines that the lane segment 305 “10,” which longitudinally touches the lane segment 305 “5,” intersects the corridor 205. In response to adding the lane segment 305 “10,” the computer 105 determines that the lane segments 305 “14” and “15,” both of which longitudinally touch the lane segment 305 “10” in the vehicle-forward direction, intersect the corridor 205. The testing of the lane segments 305 in the vehicle-forward direction may be limited by the preset travel horizon of the corridor 205.

In the example of FIG. 3, the computer 105 starts by adding the lane segment 305 “4” to the lane-segment set 325, recursively adds the lane segments 305 “3,” “5,” “9,” “10,” “12,” “14,” and “15” for laterally or longitudinally touching lane segments 305 added to the lane-segment set 325, and determines that that lane segments 305 “2,” “8,” and “13” do not intersect the corridor 205 and will not be added to the lane-segment set 325. The computer 105 leaves the lane segments 305 “1,” “6,” “7,” “11,” “14,” and “16” out of the lane-segment set 325 without determining whether those lane segments 305 intersect the corridor 205. The termination condition may be that no untested lane segments 305 remain that are laterally touching or longitudinally touching in the vehicle-forward direction any lane segments 305 in the lane-segment set 325.

The lane segments 305 in the lane-segment set 325 may define a network graph. A network graph includes a plurality of nodes and a plurality of edges each connecting two of the nodes. The lane segments 305 may be the nodes, and the relationship of laterally touching or longitudinally touching may be the edges. The use of a network graph can facilitate algorithms for finding routes that traverse the network graph.

As will be described below, the computer 105 determines the lane-level navigation route 320 based on the lane-segment set 325. The lane-level navigation route 320 includes instructions for the vehicle 100 to follow to move from lane segment 305 to lane segment 305. The lane-level navigation follows the road-level navigation route 210. For example, the lane-level navigation route 320 may stay within the corridor 205 defined from the road-level navigation route 210, and/or the lane-level navigation route 320 may include the instructions from the road-level navigation route 210, e.g., when to exit an expressway. The lane-level navigation route 320 further includes instructions for traveling from lane segment 305 to lane segment 305 within the same road segment 220, e.g., when to change lanes 310 to the lane segment 305 connected to an exit ramp. For example, the lane-level navigation route 320 may be represented as a sequence of lane segments 305, e.g., the lane segment 305 “4,” then the lane segment 305 “10,” then the lane segment 305 “14.” The lane-level navigation route 320 may include instructions from a current location of the vehicle 100 to an end of the corridor 205, i.e., through the preset travel horizon.

The computer 105 is programmed to determine the lane-level navigation route 320 based on the lane-segment set 325. For example, the computer 105 may determine the lane-level navigation route 320 by searching for an optimal route traversing the network graph. The computer 105 may execute a route-planning algorithm as is known, e.g., Dijkstra's algorithm, bidirectional search, geometric goal-directed search, reach-based routing, highway hierarchies, highway-node routing, SHARC, etc. The route-planning algorithm may search for an optimal route traversing the network graph, e.g., a route following the road-level navigation route 210 that has a lowest cost. The cost may be a sum of costs associated with each edge along the route. The costs for the edges may be assigned based on a road type and a type of transition. The road type may be expressway lane, off ramp, surface street, etc. The transition type may be remaining in a same lane 310 (e.g., the lane segment 305 “4” to the lane segment 305 “9”), changing lanes 310 (e.g., the lane segment 305 “4” to the lane segment 305 “5”), exiting onto an off ramp (e.g., the lane segment 305 “10” to the lane segment 305 “14”), etc. Changing lanes 310 may have a higher cost than remaining in a same lane 310.

The computer 105 may be programmed to operate the vehicle 100 to follow the lane-level navigation route 320. For example, the computer 105 may operate the propulsion system 120, the brake system 125, and/or the steering system 130 to follow the lane-level navigation route 320. For example, the computer 105 may operate the steering system 130 to maintain the vehicle 100 in the same lane 310 or perform a lane change, as indicated in the lane-level navigation route 320. The computer 105 may operate the vehicle 100 by executing an advanced driver assistance system (ADAS). ADAS are electronic technologies that assist drivers in driving and parking functions. Examples of ADAS include forward proximity detection, lane-departure detection, blind-spot detection, braking actuation, adaptive cruise control, and lane-keeping assistance systems. For example, the computer 105 may execute an ADAS to operate the steering system 130, e.g., a lane-keeping assistance system and/or lane-change assistance system. The computer 105 may execute the lane-keeping assistance system in response to an instruction in the lane-level navigation route 320 for the vehicle 100 to remain in the same lane 310, e.g., transitioning from the lane segment 305 “4” to the lane segment 305 “9.” The computer 105 may execute the lane-change assistance system in response to an instruction in the lane-level navigation route 320 for the vehicle 100 to change lanes 310, e.g., transitioning from the lane segment 305 “4” to the lane segment 305 “5.” The computer 105 may execute an ADAS such as the lane-keeping assistance system and/or lane-change assistance system based on data from the sensors 115, e.g., indicating boundaries of the lanes 310, other vehicles, etc. The computer 105 may execute the lane-keeping assistance system and/or lane-change assistance system in isolation or in conjunction with an adaptive cruise control system that operates the propulsion system 120 and/or the brake system 125.

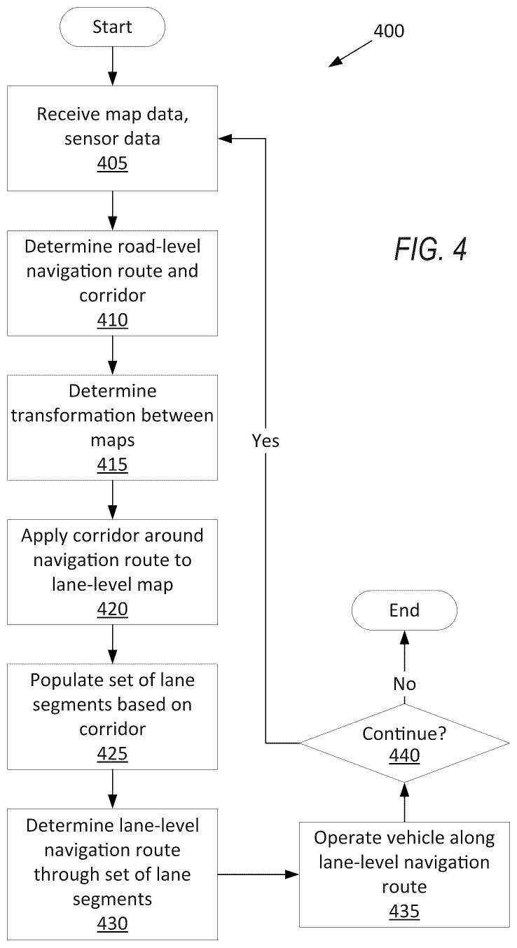

FIG. 4 is a flowchart illustrating an example process 400 for determining the lane-level navigation route 320 and operating the vehicle 100 along the lane-level navigation route 320. The memory of the computer 105 stores executable instructions for performing the steps of the process 400 and/or programming can be implemented in structures such as mentioned above. As a general overview of the process 400, the computer 105 receives the map data and sensor data, determines the road-level navigation route 210 and the corridor 205, determines the transformation between the road-level map 200 and the lane-level map 300, applies the corridor 205 to the lane-level map 300, populates the lane-segment set 325, determines the lane-level navigation route 320, and operates the vehicle 100 to follow the lane-level navigation route 320. The process 400 may continue for as long as an ADAS is active or for as long as the vehicle 100 remains on.

The process 400 begins in a block 405, in which the computer 105 receives the road-level map 200, the lane-level map 300, and data from the sensors 115, as described above.

Next, in a block 410, the computer 105 determines the road-level navigation route 210 based on the road-level map 200 from the block 405, and the computer 105 generates the corridor 205 defining a geometric area surrounding the road-level navigation route 210, as described above.

Next, in a block 415, the computer 105 determines the transformation between the road-level map 200 and the lane-level map 300 from the block 405, as described above.

Next, in a block 420, the computer 105 applies the corridor 205 to a lane-level map 300 based on the transformation from the block 415, as described above.

Next, in a block 425, the computer 105 populates the lane-segment set 325 with a subset of the lane segments 305 from the lane-level map 300 based on the application of the corridor 205 to the lane-level map 300 in the block 420, as described above. The computer 105 may first reset the lane-segment set 325 to be empty, e.g., if the process 400 has executed at least once.

Next, in a block 430, the computer 105 determines the lane-level navigation route 320 based on the lane-segment set 325 from the block 425, as described above.

Next, in a block 435, the computer 105 operates the vehicle 100 to follow the lane-level navigation route 320 from the block 430, as described above.

Next, in a decision block 440, the computer 105 determines whether to continue the process 400. For example, the computer 105 may determine whether the vehicle 100 is still on, or the computer 105 may determine whether the ADAS features being used in the block 435 are still active. If the vehicle 100 is still on and the ADAS features are still active, the process 400 returns to the block 405. Otherwise, the process 400 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. Operations, systems, and methods described herein should always be implemented and/or performed in accordance with an applicable owner's/user's manual and/or safety guidelines.

The disclosure has been described in an illustrative manner, and it is to be understood that the terminology which has been used is intended to be in the nature of words of description rather than of limitation. Use of “in response to,” “upon determining,” etc. indicates a causal relationship, not merely a temporal relationship. Many modifications and variations of the present disclosure are possible in light of the above teachings, and the disclosure may be practiced otherwise than as specifically described.

What is claimed is:

1. A computer comprising a processor and a memory, the memory storing instructions executable by the processor to:
generate a corridor defining a geometric area surrounding a road-level navigation route for a vehicle;
apply the corridor to a lane-level map, the lane-level map including a plurality of lane segments, each lane segment defining a lane of a road from one endpoint to another endpoint;
populate a lane-segment set with a subset of the lane segments from the lane-level map based on the application of the corridor to the lane-level map; and
determine a lane-level navigation route based on the lane-segment set, the lane-level navigation route following the road-level navigation route.

2. The computer of claim 1, wherein the instructions further include instructions to operate the vehicle to follow the lane-level navigation route.

3. The computer of claim 1, wherein the instructions further include instructions to operate a steering system of the vehicle to follow the lane-level navigation route.

4. The computer of claim 3, wherein the instructions to operate the steering system to follow the lane-level navigation route include instructions to perform a lane change.

5. The computer of claim 1, wherein the corridor extends laterally from the road-level navigation route for a preset width centered on the road-level navigation route.

6. The computer of claim 5, wherein the preset width is greater than a width of one of the lane segments.

7. The computer of claim 1, wherein the corridor follows the road-level navigation route up to a preset travel horizon.

8. The computer of claim 1, wherein the instructions further include instructions to include the lane segments that at least partially intersect the corridor as applied to the lane-level map in the lane-segment set.

9. The computer of claim 8, wherein the instructions further include instructions to individually determine whether the lane segments in the lane-level map intersect the corridor as applied to the lane-level map in an order starting with a closest lane segment to the vehicle.

10. The computer of claim 9, wherein the order progresses through the lane segments laterally touching the lane segments in the lane-segment set until one of the lane segments does not intersect the corridor.

11. The computer of claim 9, wherein the order progresses in a vehicle-forward direction through the lane segments longitudinally touching the lane segments in the lane-segment set until one of the lane segments does not intersect the corridor.

12. The computer of claim 1, wherein the road-level navigation route is generated from a road-level map.

13. The computer of claim 1, wherein the instructions further include instructions to determine a transformation between a road-level map and the lane-level map, and apply the corridor to the lane-level map based on the transformation.

14. The computer of claim 1, wherein the lane segments in the lane-segment set define a network graph, and the instructions further include instructions to determine the lane-level navigation route by searching for an optimal route traversing the network graph.

15. A method comprising:
generating a corridor defining a geometric area surrounding a road-level navigation route for a vehicle;
applying the corridor to a lane-level map, the lane-level map including a plurality of lane segments;
populating a lane-segment set with a subset of the lane segments from the lane-level map based on the application of the corridor to the lane-level map, each lane segment defining a lane of a road from one endpoint to another endpoint; and
determining a lane-level navigation route based on the lane-segment set, the lane-level navigation route following the road-level navigation route.

16. The method of claim 15, further comprising operating the vehicle to follow the lane-level navigation route.

17. The method of claim 15, wherein the corridor extends laterally from the road-level navigation route for a preset width centered on the road-level navigation route.

18. The method of claim 15, further comprising including the lane segments that at least partially intersect the corridor as applied to the lane-level map in the lane-segment set.

19. The method of claim 15, wherein the road-level navigation route is generated from a road-level map.

20. The method of claim 15, further comprising determining a transformation between a road-level map and the lane-level map, and applying the corridor to the lane-level map based on the transformation.
